(19) United States
(12) Patent Application Publication
(10) Pub. No.: US 2011/0295724 A1
(43) Pub. Date: Dec. 1, 2011

(54) METHODS AND SYSTEMS FOR TRACKING AND MONITORING INVENTORY

(75) Inventor: Clyde HILL, Alpharetta, GA (US)

(73) Assignee: DataScan Technologies, LLC, Alpharetta, GA (US)

(21) Appl. No.: 13/097,577

(22) Filed: Apr. 29, 2011

Related U.S. Application Data
(60) Provisional application No. 61/329,891, filed on Apr. 30, 2010.

(51) Int. Cl. G06Q 10/00; G06Q 40/00

(52) U.S. Cl. 705/28

(57) ABSTRACT

Apparatus and methods for monitoring and tracking collateral and inventory are disclosed. The methods include receiving location information and collateral or inventory identification information from one or more location devices attached to one or more pieces of collateral or inventory. The methods also include storing the received location and collateral or inventory identification information for the one or more pieces of collateral or inventory and identifying a location of one more pieces of collateral or inventory using the received location and collateral or inventory identification information. The methods further include presenting on a dashboard information regarding the location of the one or more pieces of collateral or inventory.

### CROSS-REFERENCE TO RELATED APPLICATIONS

This application claims priority to the following application: U.S. Provisional Application No. 61/329,891, titled “Methods and Systems for Tracking and Monitoring Inventory,” filed on Apr. 30, 2010, which is incorporated by reference herein in its entirety.

### BACKGROUND OF THE INVENTION

1. Field of the Invention

Aspects of the present invention relate to methods and systems for managing inventory for onsite vendors and the finance companies that finance the inventory of onsite vendors. In particular, variations of the present invention relate to methods and systems for performing remote verification and tracking of inventory and collateral for onsite vendors and the finance companies that finance the inventory of onsite vendors.

2. Background of the Related Art

Typically in floorplan lending, or wholesale lending, a vendor's inventory is financed by making a loan advance against a specific piece of collateral, e.g., an automobile, boat, or other item often sold under a sales finance contract. Thus, an equipment or vehicle vendor, such as a car dealer, typically owns the vehicles present on the dealer's premises subject to liens or other security interests that have been granted to a floorplan lender such as a bank or other financial institution.

In assessing the vendor's compliance with its floorplan loans, collateral verification specialists may be regularly sent out by a financial institution to a vendor's location for monitoring and inspecting the inventory at the vendor's location. The information gathered by the collateral verification specialists may be used by the floorplan lender to compare the information disclosed by the vendor, and an assessment of the financial health or of the financial risk presented by the vendor can thereby be made. Such an assessment can be made with respect to, for example, the number, types, and specific identification by serial number of vehicles present in the vendor lot, the physical state of the vehicles, the age of the vehicles, and the like. The financial information of the vendor may include, for example, the quantities and specific identification of vehicles sold during a given period of time, the interest to be paid on any loans taken out by the car vendor, the payment history of the car vendor, and the like. The typical collateral verification process of sending individuals to the vendor location, locating and inspecting the collateral, and tracking down missing collateral is a time and other resource intensive process.

Radio-frequency identification (RFID) chips have been used in the related art for tracking the location of vehicles remotely. However, while the RFID chips can identify the location of a vehicle or other item via the RFID chip, these chips alone do not allow identification with certainty of the vehicle in which the RFID chip is theoretically located. For example, there is a risk that the RFID chips may be removed from the vehicle and placed in a different location or in another vehicle. Thus, the information transmitted from the RFID chips cannot always be relied upon to be representative of the location of the specific vehicle being tracked, but instead, at most only absolutely represent the location of the RFID chips themselves.

There remains a need in the art for additional methods and systems for remotely identifying and tracking the location of financed collateral in helping to assess the risk of a loan.

### SUMMARY

Aspects of the present invention include methods for reducing the effort required to perform inventory verifications. The methods may include receiving location information and collateral identification information from one or more location devices attached to one or more pieces of collateral. In addition, the methods may include storing the received location and collateral identification information for the one or more pieces of collateral and identifying a location of one more pieces of collateral using the received location and collateral identification information. The methods may also include presenting on a dashboard information regarding the location of the one or more pieces of collateral.

Aspects of the present invention may also include systems for reducing the effort required to perform collateral verifications. The system may include an information management system operable to receive location information and collateral identification information from one or more global positioning system devices attached to one or more pieces of collateral and store the received location and collateral identification information for the one or more pieces of collateral. In addition, the system may include the information management system being further operable to identify a location of the one more pieces of collateral using the received location and collateral identification information and present on a dashboard information regarding the location of the one or more pieces of collateral.

### DESCRIPTION OF THE FIGURES

In the drawings:

FIG. 1 illustrates an example flow diagram of a method for monitoring and tracking the location of collateral in accordance with an aspect of the present invention;

FIG. 2 illustrates an example flow diagram of a method for creating a boundary for one or more location devices in accordance with yet another aspect of the present invention;

FIG. 3 illustrates an example communication system in accordance with aspects of the present invention;

FIGS. 4A-4G illustrate example interfaces for use with aspects of the present invention;

FIG. 5 illustrates various features of an example computer system for use in conjunction with aspects of the present invention; and

FIG. 6 illustrates an exemplary system diagram of various hardware components and other features, in accordance with aspects of the present invention.

### DETAILED DESCRIPTION

Aspects of the present invention include methods and associated systems that, among other things, provide time and resource savings when performing remote collateral verification and tracking of the financed inventory of onsite vendors, such as an equipment dealer or vehicle vendor, by, for example, the entity that finances the inventory, e.g., financial institutions or banks.

Aspects of the present invention may include, for example, an inventory management system for managing the financed inventory onsite at the vendor locations (e.g., the amount of and specific units of inventory that should be present onsite at the vendor). In addition, aspects of the present invention may also include a global positioning system (GPS) for locating the financed inventory. Other aspects of the present invention may also include methods and systems for associating the financed inventory's identity (e.g., a vehicle identification number) with the inventory's GPS location. Further aspects of the present invention may include systems and methods for assessing the risk of a floor plan loan (e.g., wholesale lending where a vendor's inventory is financed by a loan advance against a specific piece of collateral). It should be appreciated that using aspects of the present invention in combination may provide time and resource savings when performing remote collateral verification and tracking of inventory of onsite vendors, such as an equipment dealer or vehicle vendor, by, for example, the entity that finances the inventory, e.g., financial institutions or banks.

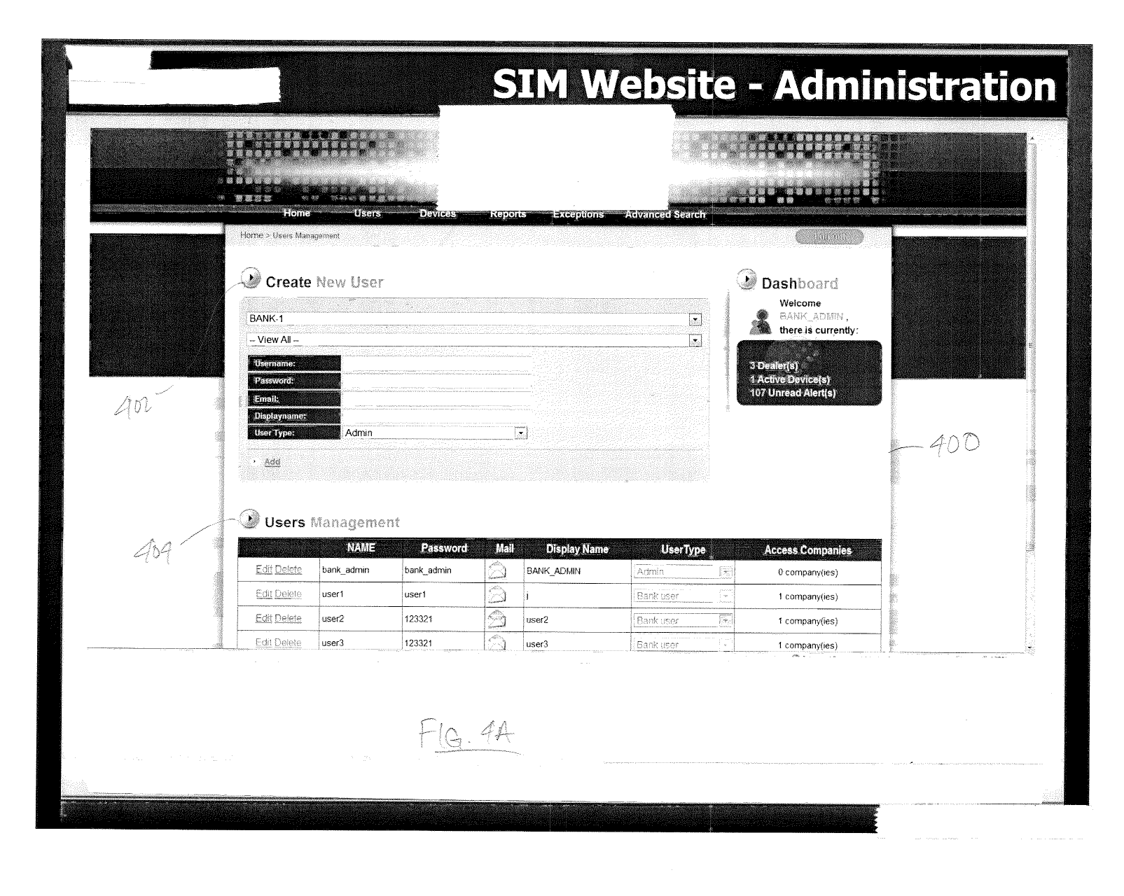

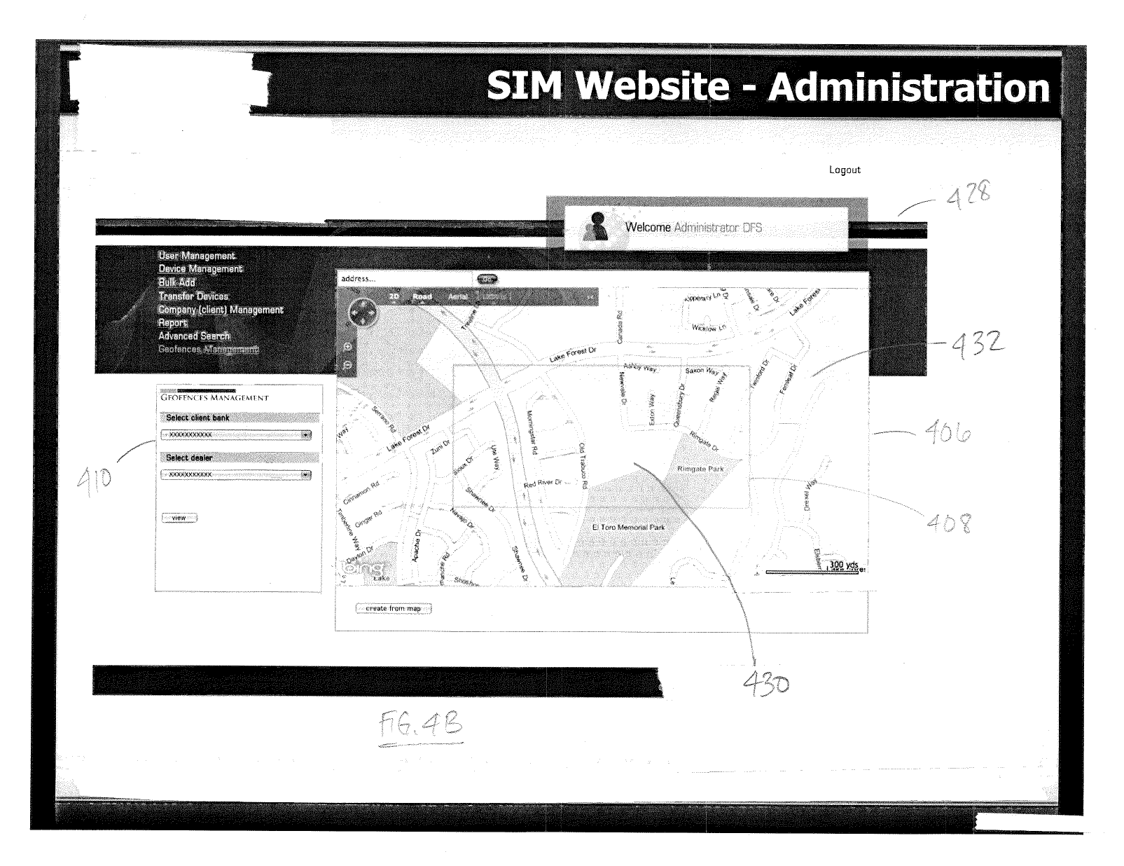

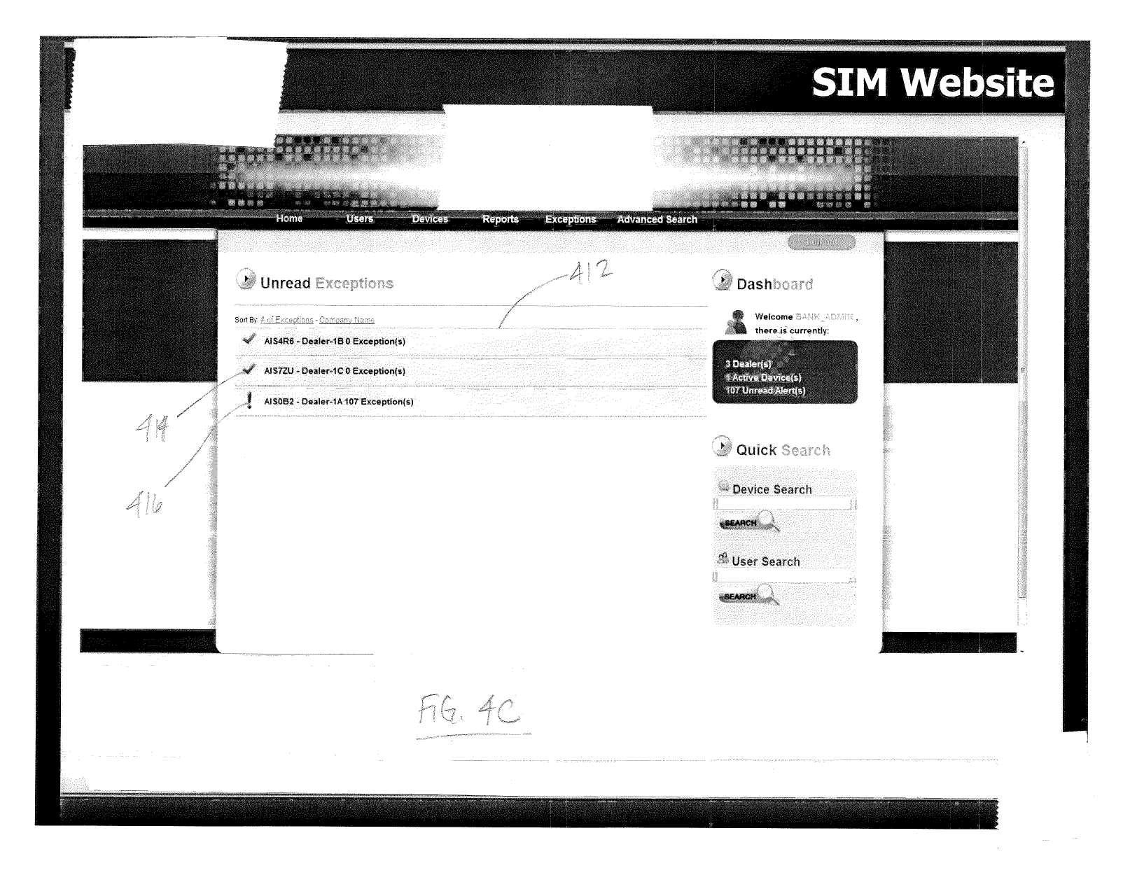

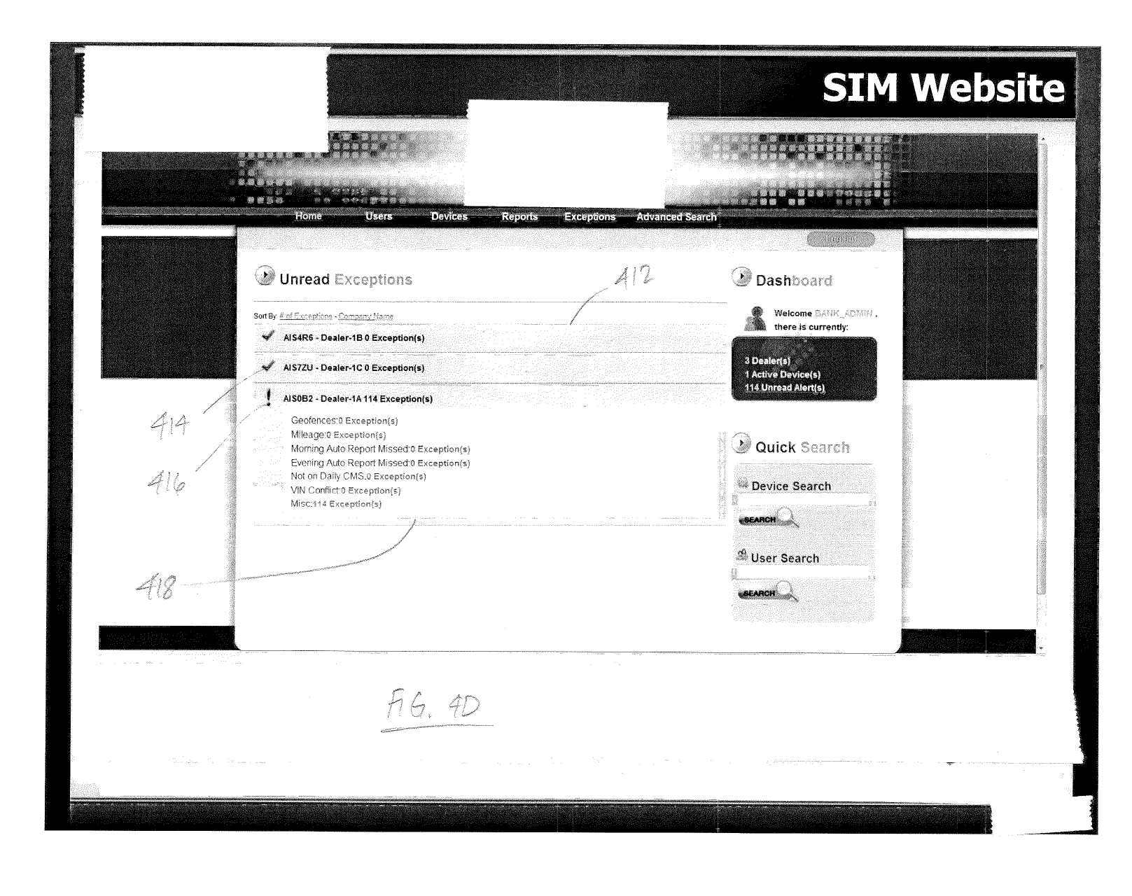

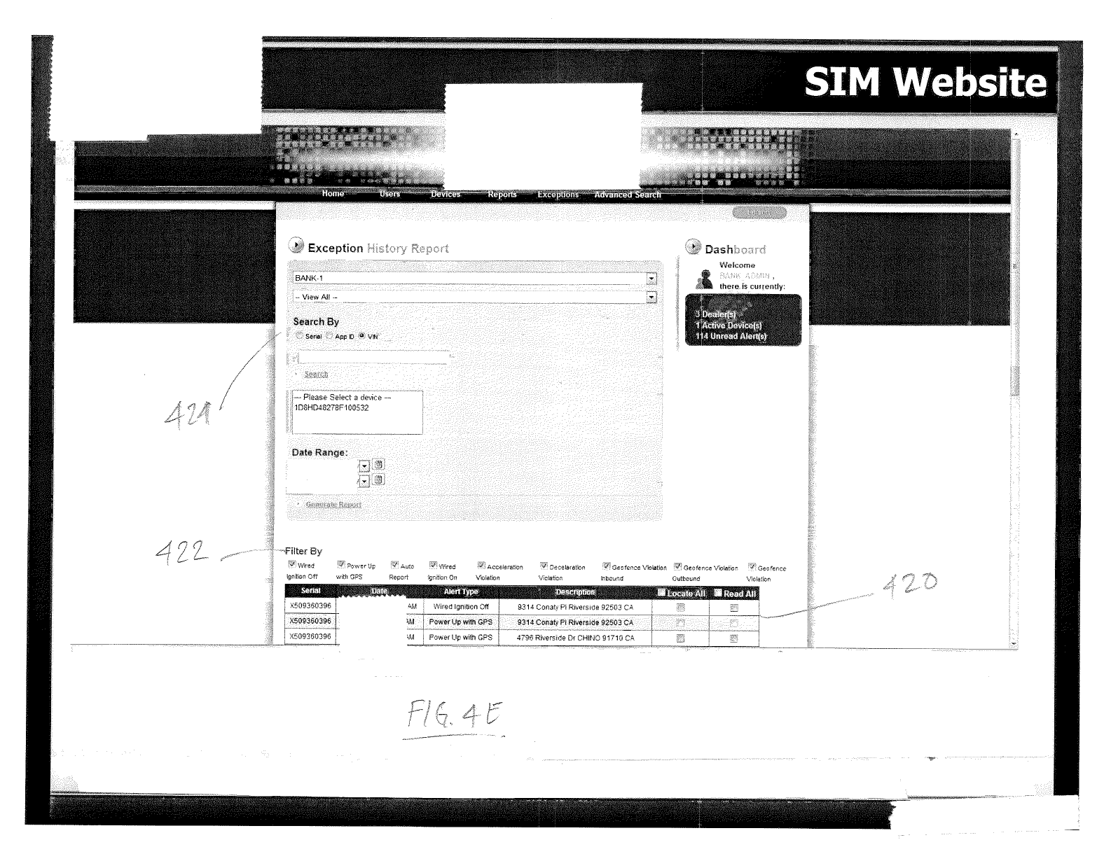

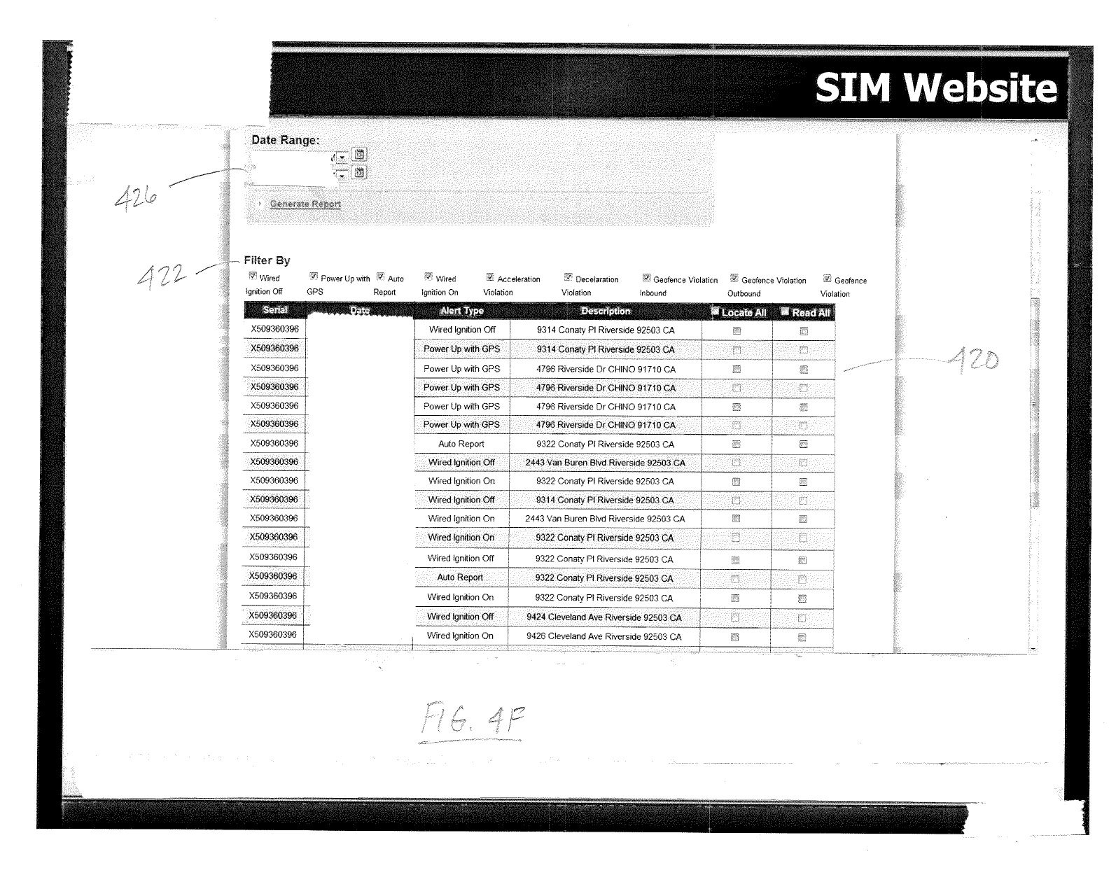

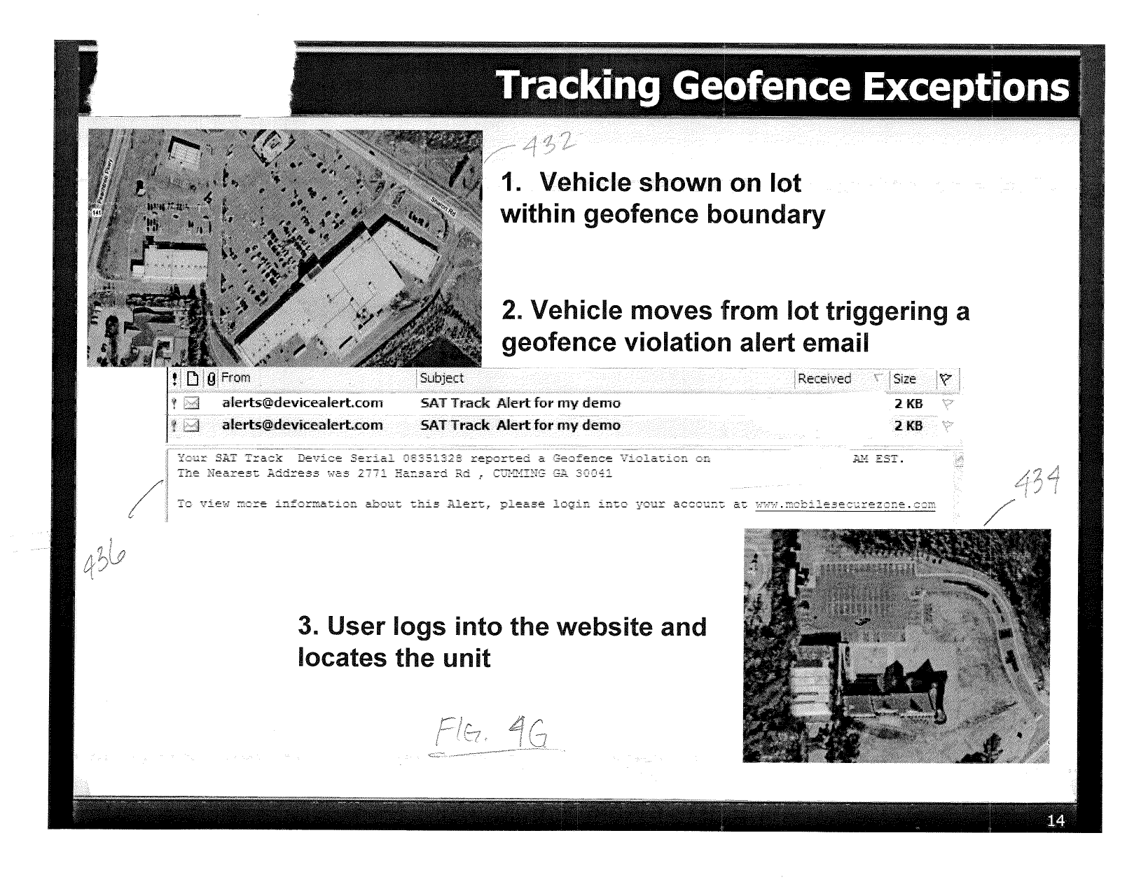

Aspects of the present invention may be implemented via one or more user interface features (also referred to interchangeably herein as “dashboards”), which assist users through various steps or acts of tracking and monitoring inventory, as illustrated for example in FIGS. 4A-4G, described further below. The interactive dashboards may provide flexibility for customizing unique or specific issues relating to verifying and monitoring collateral. The interactive platform may include a series of interactive interfaces and other database or repository interfaces that may provide at least the following capabilities: adding and managing users, receiving input regarding a location and an identification of the collateral being tracked (e.g., via an incorporated inventory management system, such as Product Management System and Method), receiving and/or reviewing alerts relating to the collateral, establishing boundaries for the collateral to remain within (also interchangeably referred to herein as a “geo-fence”), tracking the movement of the collateral, and running reports, among other functionality.

Users of the system may include, for example, financial institutions, administrators, and/or vendors, among other users. Various users may have various levels of access, depending on the user's security. For example, an administrator may have the ability to: add and remove users, assign passwords and/or create user identifications, and modify the boundaries for the collateral to remain within, among other administrative activities. Further, a financial institution may have the ability to: review a listing of the vendors it finances, review the inventory for the vendors it finances, track the location of the inventory, review reports relating to the inventory, and receive alerts relating to the inventory, among other user activities. In addition, a vendor may be able to use the system for assisting in managing the vendor's onsite inventory. For example, a car dealership may track the location and the status of the cars that the dealership owns.

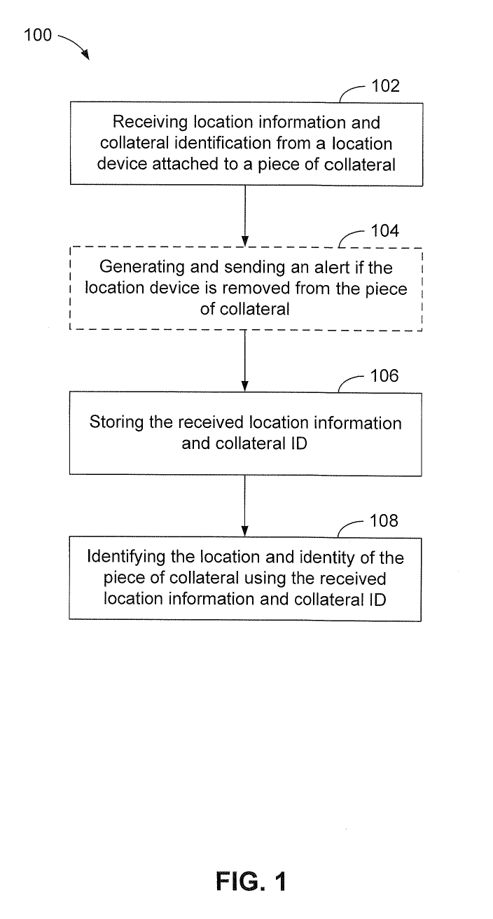

According to various aspects of the present invention, the user may monitor and track the location of the pieces of collateral and inventory. Referring now to FIG. 1, illustrated is an example method 100 for monitoring and tracking pieces of collateral in accordance with an aspect. The method may include receiving location information and collateral identification (ID) from a location device attached to a piece of collateral 102. In an aspect, the pieces of collateral may be tracked using one or more global positioning system (GPS) components, e.g., a GPS beacon, a GPS receiver, or other geographical location component, such as cellular location devices and components, attached or coupled to each piece of collateral. The GPS beacons may identify the location of each individual piece of collateral, along with the identity of each piece of collateral. For example, the GPS beacon may be connected to the onboard diagnostic port of a vehicle and the vehicle's electronic control unit (ECU). As the ECU provides power to the GPS beacon, the GPS beacon may also securely provide the vehicle identification number (VIN) for the vehicle, along with the location information for the vehicle.

The method may optionally include generating and sending an alert if the location device is removed from the piece of collateral 104. In an aspect, upon removing the GPS beacon from the vehicle, a final position of the vehicle and a disconnect alert may be transmitted from the GPS beacon to the system. It should be appreciated that if the GPS beacon is removed from the vehicle, then the power source from the ECU is stopped and the GPS beacon will discontinue transmitting information relating to the piece of collateral (e.g., VIN). Further, it should be appreciated that if the GPS beacon is placed into a new vehicle, then the GPS beacon will start transmitting the location information and VIN number for the new vehicle. Thus, a user monitoring the pieces of collateral will be able to determine whether the VIN transmitting from a GPS beacon is the same VIN for the piece of collateral that should be monitored. Moreover, it should be appreciated that if the GPS beacon is removed from the vehicle, an alert may be generated to the user notifying the user that the GPS beacon has been removed from the vehicle. The alert may include, for example, a short message service (SMS) text message, an e-mail message, a telephone call, an icon appearing on the dashboard, or a link to a map showing the location of the collateral, among other alerts. In some variations, the user may thereby receive real-time alerts that the GPS beacon has been disconnected or placed into another vehicle.

The method may also include storing the received location information and collateral ID 106. According to various aspects of the present invention, the data gathered by the GPS beacon may be transmitted and uploaded to the dashboard. Processing of the GPS beacon data can include transmission and storage of the data in the dashboard. For example, the location information may be associated and stored with the collateral ID. Transmission of the data can be performed via cable, wireless, fiber optic, Internet, or any other transmission technique, now or later available.

The method may further include identifying the location and identity of the piece of collateral using the received location information and collateral ID 108. A user may input the collateral ID to access the location information associated with the selected collateral ID. In addition, the user may access the collateral ID by inputting the location and receiving a list of collateral IDs at the selected location. In an aspect, users may remotely identify the location and identity of the financed inventory real-time, e.g., 24 hours a day, 7 days a week, instead of waiting for the results of an audit. Thus, the user is capable of monitoring the location of the inventory at the vendor without dispatching an individual to the onsite vendor to survey the inventory present at the vendor.

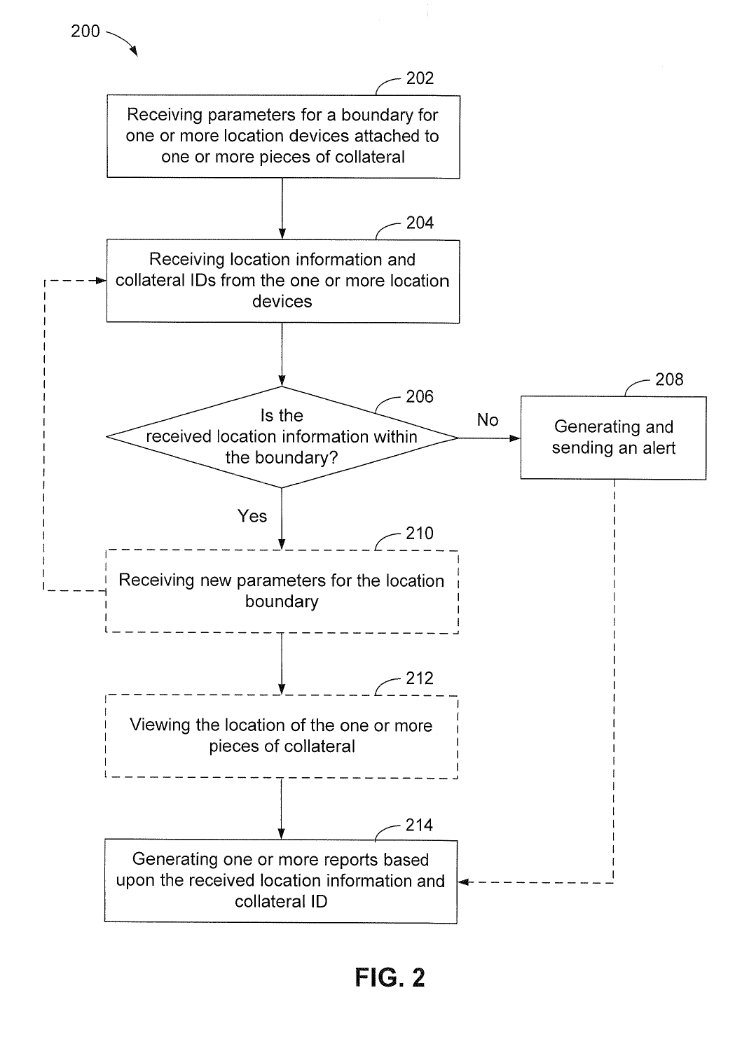

The user may also use the dashboard for creating a virtual boundary, also interchangeably referred to herein as a “geo-fence,” setting parameters that the GPS beacon must remain within. Referring now to FIG. 2, illustrated is a method flow 200 for creating a boundary for one or more location devices in accordance with an aspect of the present invention. The method may include receiving parameters for a boundary for one or more location devices attached to one or more pieces of collateral 202. The parameters for the geo-fence may include, for example, setting a distance surrounding the dealership, setting a distance surrounding a plurality of vehicles, and/or setting a distance surrounding an offsite location (e.g., a shopping center, golf course, or airport), among other parameters. For example, a user may select a center point at a location and a radius may be calculated from the selected center point for the geo-fence parameters. In another aspect, the user may drag the line on a map to illustrate the parameters for the geo-fence. The user may also select a landmark (e.g., a park, building, retail establishment, a restaurant, a golf course, or airport, among other landmarks) on a map to establish the geo-fence parameters, among other methods for selecting the parameters of the geo-fences. In some variations, the user may send a request to an administrator for creating a geo-fence with the parameters selected by the user.

The method may also include receiving location information and collateral IDs from the one or more location devices 204. As discussed above in FIG. 1, GPS beacons may identify the location of each individual piece of collateral, along with the identity of each piece of collateral. For example, the GPS beacon may be connected to the onboard diagnostic port of a vehicle and the vehicle's ECU. As the ECU provides power to the GPS beacon, the GPS beacon may also securely provide the vehicle identification number (VIN) for the vehicle, along with the location information for the vehicle.

In addition, the method may include determining whether the received location information is within the boundary 206. For example, the dashboard can compare the received location from the GPS beacon to the perimeter location to verify whether the beacon location is within the perimeter of the geo-fence boundary. In some variations, each GPS beacon can be communicated with individually to determine whether the GPS beacon has moved outside of the geo-fence. In an aspect, the geo-fence parameters may be illustrated graphically on a map. For example, the geo-fence parameters may be illustrated by a line surrounding a dealership and the GPS beacons may be illustrated by circles within the line. A user may view the map with the GPS beacons and determine whether any of the GPS beacons are outside of the geo-fence boundary.

If the received location information is outside of the boundary, the method may include generating and sending an alert 208. For example, if the vehicle moves outside of the geo-fence, then an alert may be sent notifying the user that an exception has occurred. The alert may include, for example, a SMS message, an e-mail message, a telephone message, or an icon appearing on the dashboard, among other alerts. Information sent with the alert may include, for example, the identification of the vehicle that has moved outside of the geo-fence, the nearest address to the violation, and/or a link to a map illustrating the location of the vehicle. Thus, the user can use the alert to identify when the vehicle left the geo-fence and to track the movement of the vehicle. It should be appreciated that the alert may be altered for normal business behavior, e.g., taking the cars for test drives.

The method may optionally include receiving new parameters for the location boundary 210. It should be appreciated that the parameters for the geo-fence can be modified remotely by the user. The user may enter new parameters for the geo-fence, e.g., a new distance radius, or the user may drag the line on the map to illustrate the new parameters, among other things. In an aspect, the user may set up a temporary geo-fence for the vehicles. For example, if the vehicles are on display or loan at another location, then a temporary geo-fence may be set for the other location during the time period the vehicles are to remain at the temporary location. It should be appreciated that the geo-fence parameters may be customized for each dealership individually.

In addition, the method may optionally include viewing the location of the one or more pieces of collateral using the received location information and collateral ID 212. According to various aspects of the present invention, the user may use the dashboard for performing remote inventory management. Remote inventory management may include reviewing the GPS beacon data and determining whether the financed inventory is located on the vendor's premises.

In an aspect of the present invention, the user may use mapping applications running on the dashboard for locating the financed inventory in real-time. For example, the user may search a vehicle using the dashboard, e.g., by VIN, and view on a map where the vehicle is located. Thus, the user may be able to view graphically whether the car is within the boundary of the dealership lot, driving down a road, on display (e.g., at an airport, shopping mall, golf tournament), or parked in a driveway, among other locations. Viewing the location of the vehicle on a map may give a user a starting point for resolving why the vehicle is missing from the lot, or provide the user the last location report received from the vehicle

In another aspect, the user may log onto the dashboard and view or otherwise obtain a listing of vendors with the GPS beacons at the vendor locations. The listing of vendors may include an icon, e.g., a check mark or exclamation point, indicating whether an alert or exception was issued by a GPS beacon at that vendor. An alert and/or exception may include, for example, the GPS beacon exceeding the geo-fence boundary, the GPS beacon leaving the geo-fence and failing to return to the vendor within a time period that has been pre-set, the GPS beacon failing to report data, removing the GPS beacon from the collateral, the GPS beacon exceeding a mileage limit, or selling the collateral, among other alerts and/or exceptions. It should be appreciated that the exceptions may be altered for normal business behavior, e.g., taking the cars for test drives. A check mark indicated on the interface may indicate, for example, that no alerts and/or exceptions have been issued by the GPS beacons at that particular vendor, and an exclamation point may indicate, for example, that an alert and/or exception has been issued by one of the GPS beacons at that particular vendor. In an aspect, the user may follow up on the alerts and/or exceptions (e.g., collateral that may be missing from the vendor) using a listing indicating what inventory should be present at the vendor location, or other vendor information. For example, the user may have a listing identifying all of the cars that should be located on a car dealer's lot.

The method may also include generating one or more reports based upon the received location information and collateral ID 214. The dashboard may run one or more reports comparing the vendor information with the reported missing inventory from the vendor provided by the GPS beacons. The reports may generate, for example, a list of the cars present on the dealership lot, along with a list of the cars not present on the dealership lot, and how long the cars have been on or off the dealership lot.

Other aspects of the virtual inventory or collateral check or verification may include, for example, determining the sales history of the inventory, among other inventory checks. The information gathered from the virtual inventory check may provide the user with a real-time update on the sales status of the financed inventory for the vendor. For example, the user may access a dealership's dealer management system (DMS) for determining when a car was sold, the customer name, finance source, when the dealership received payment for the vehicle, when the vehicle left the dealership, among other sales or vehicle status information. Such information may also be preset or transmitted from the DMS to the inventory management system, for example. Thus, the user knows real-time what inventory was sold, when the inventory was sold, how many vehicles should be present on the lot, and how many vehicles are missing off the lot.

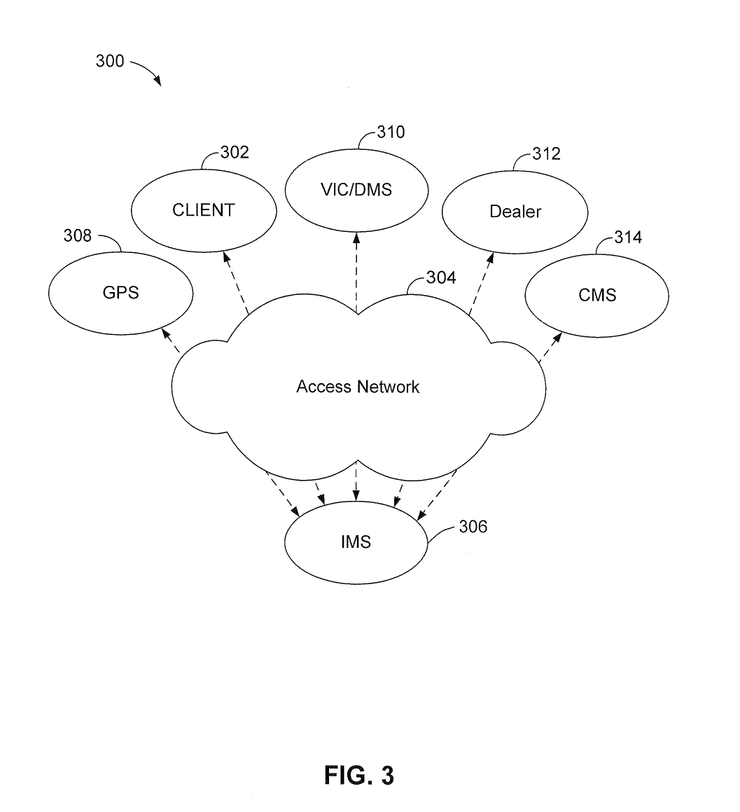

Referring now to FIG. 3, illustrated is an example communication system 300 with one or more inventory management systems (IMS) 306 communicating via access network 304 with one or more systems, such as client 302, global positioning system 308, virtual inventory check (VIC)/dealer management system (DMS) 310, dealer 312, and collateral management systems (CMS) 314, in accordance with aspects of the present invention. It should be appreciated that client 302, GPS 308, VIC/DMS 310, dealer 312, and CMS 314 may comprise wireless devices and/or computing devices. Wireless devices may include any mobile, portable computing or communications device, such as a cellular device, that may connect to an access network 304. For example, wireless devices may include a cellular telephone, a navigation system, a global positioning system (GPS), a computing device, a camera, a PDA, or a handheld device having wireless connection capability, among other devices. Server and/or computing devices may include, for example, any mobile or fixed computing device connected to a network.

Inventory management system (IMS) 306 may use the input received from one or more systems, such as client 302, global positioning system 308, virtual inventory check (VIC)/dealer management system (DMS) 310, dealer 312, and collateral management systems (CMS) 314 to aid users in managing and tracking inventory, such as floor planned collateral. In an aspect, IMS 306 may receive input from CMS 314 with information identifying one or more pieces of floor planned collateral. For example, CMS 314 may provide information regarding locations and an identifications of collateral being tracked.

In addition, IMS 306 may receive input from GPS 308 with the location of one of or more pieces of inventory or collateral, along with the identity of each piece of inventory or collateral. IMS 306 may use the location information provided by GPS 308 to locate and identify one or more pieces of inventory collateral.

IMS 306 may also receive information regarding the financed inventory onsite at the vendor locations (e.g., the amount of and specific units of inventory that should be present onsite at the vendor) and the sales status of one or more pieces of inventory from VIC/DMS 310. It should be appreciated that the information provided from VIC/DMS 310 may relate to the changes in inventory (e.g., the sales status of one or more pieces of inventory) at one or more dealerships in real-time or near real-time. A user may use IMS 306 to assist in managing and tracking the inventory at one or more dealerships in real-time to know what inventory was sold, when the inventory was sold, how many vehicles should be present on the lot, and how many vehicles are missing off the lot

According to various aspects of the present invention, the user may use client system 302 to communicate with IMS 306 and may use the information from the virtual inventory check or collateral verification for assessing the financial health of the vender or the financial risk of the loan to the vendor. In addition, the user may use the information from the virtual inventory check or collateral verification for determining whether any subsequent loans requested by the vendor may be granted. Such an assessment can be made with respect to, for example, the number and types of vehicles present on the vendor lot, the physical state of the vehicles, the age of the vehicles, compliance with sold unit repayment requirements, and the like. In addition, the user may have information on the vendor including: the number and types of loans granted to the vendor, repayment history of the loans by the vendors, number and types of vehicles or articles being sold, average time that a vehicle or article present on the lot or in inventory is sold, level of consistency between data gathered by the dashboard and data disclosed by the vendor, and many other such relevant parameters.

If the vendor has a long history of timely payments on loans, has never or rarely defaulted on any loan, and the record inventory provided by the vendor reflects the collateral verification results obtained by the collateral verification specialists of the financial institution, then the financial health of that vendor may be determined to be good, for example. On the other hand, if the vendor has a spotty repayment history, and discloses inventory that does not match the collateral verification results obtained by the collateral verification specialists of the financial institution, then the financial health of that vendor may be determined to be bad. Thus, the user may obtain an accurate financial picture of their business via the dashboard.

Among other things, the financial institution may also undertake a statistical analysis of the history of a given car dealer in order to obtain a snapshot of the financial health of the car dealer to predict the financial health of the car dealer. Future dealings with the car dealer may be made on the basis of that prediction. For example, if the analysis determines that the car dealer is likely to file for bankruptcy, then loans may be rescinded and cars from the lot may be repossessed. Also, if the financial analysis of a given car dealer reveals that the financial health of the car dealer is declining, then the financial institution may order more frequent audits of the car dealer.

In an aspect, a vendor may use dealer system 312 to communicate with IMS 306 and use the information stored within IMS 306 for assisting the vendor in managing the vendor's onsite inventory. The vendor may use the system for tracking inventory that the vendor owns. For example, the vendor may use the information from the GPS beacon device for determining the location and status of the cars that the dealership owns in real-time or near real-time.

In one optional variation, upon receiving a report from the dashboard indicating that some of the financed inventory is missing from a vendor's site, as part of a collateral verification, for example, the user may send monitors to the onsite vendors, such as the car dealer, to survey the site and reconcile the missing cars from the dealership lot. For example, the collateral verification specialist may know from the report generated by the dashboard that 50 cars are missing from the 200 cars that should be in inventory at the car dealership, and of those 50 cars, 30 cars have been sold. Thus, when the collateral verification specialist visits the dealership, he or she can focus on reconciling why 20 cars are missing from the dealership lot, instead focusing on the entire inventory. Therefore, the time the collateral verification specialist spends at the dealership lot verifying the inventory can be reduced. In another aspect, monitors may be sent periodically to the vendor's site for verifying the information gathered by the GPS beacons. For example, the collateral verification specialists may spot-check the data received from the GPS beacons to verify that the vehicles are in the location where the GPS beacons are indicating. The information gathered by the collateral verification specialists onsite may be compared and verified with the information stored in the dashboard.

In another optional aspect, the dashboard may be used for performing a fence and hold on the inventory to prevent the inventory from moving from the vendor location. For example, if a dealership is taken over by a lender, generally a time lag occurs before the lender is able to remove the inventory off the dealership lot. During the time lag, some of the inventory sometimes can disappear from the lot before the lender can take control of the inventory. Thus, in an aspect, the user may use the dashboard to create a virtual secure storage of the inventory on the dealership lot until the lender can take possession of the inventory. For example, the user may tighten the geo-fence boundaries for the GPS beacons on the inventory so that if the vehicles move at all, an alert is sent notifying the user that the inventory is moving. It should be appreciated that the alert may include a SMS message, an electronic mail message, or a telephone call, among other alerts. Thus, the user may be notified immediately if any of the inventory moves before the lender takes control of the inventory.

Another variation of the present invention includes placing a notification on the collateral indicating that the piece of collateral is being tracked. For example, a warning sticker may be placed on a vehicle's window indicating to potential buyers and the dealership that the vehicle is being tracked remotely. Thus, once a buyer purchases a vehicle, the notification may remind the buyer and dealership to remove the GPS beacon device from the vehicle before the buyer removes the vehicle off the dealership lot.

Referring now to FIGS. 4A-4G, illustrated are example interfaces for use with aspects of the present invention. An example GUI screen 400 for user administration and/or management in accordance with an aspect of the present invention is illustrated in FIG. 4A. GUI screen 400 may have a user input area 402 for inputting new user information into the system. New user information may include, but is not limited to, usernames, user passwords, user e-mail addresses or other forms of user contact information, a display name, and user type (e.g., administrator, financial institution, vendor, bank employee, or car dealership, among other user types), among other new user information. In addition, GUI screen 400 may also include a user management area 404 which allows a user with administrative privileges, for example, the opportunity to edit and/or delete user information for one or more users of the system.

Referring now to FIG. 4B, illustrated is an example GUI screen 428 for geo-fence management in accordance with another aspect of the present invention. GUI screen 428 may include a map 406 displayed with a boundary 408 outlining the selected geo-fence area. For example, if a vehicle moved from the area 430 within the geo-fence boundary to the area 432 outside the geo-fence boundary, the vehicle may be considered to be outside of the geo-fence 408. It should be appreciated that the boundary for the geo-fence may be modified by the user. For example, the user may use an input device (e.g., a mouse) to drag the line on the map to illustrate the new boundary, among ways to change the boundary for the geo-fence. In addition, GUI screen 428 may include a geo-fence management area 410 where a user of the system may select one or more geo-fences to view.

Aspects of the present invention may also include receiving and displaying alerts and/or exceptions for collateral at a location, as illustrated in FIGS. 4C-4F. Referring now to FIGS. 4C-4D, illustrated are example GUI screens for displaying a location list 412 and the associated exceptions and/or alerts 418 for a location in accordance with an aspect of the present invention. In an aspect, location list 412 may include an icon, such as a check mark 414 or an exclamation mark 416, to indicate whether exceptions and/or alerts 418 are associated with the location. Check mark 414 may indicate, for example, that no alerts and/or exceptions have been issued at that particular location. Exclamation mark 416 may indicate, for example, that an alert and/or exception 418 has been issued at the particular location. Alerts and/or exceptions 418 may include, but are not limited to, a vehicle report was missed (e.g., a GPS beacon failing to report data), a vehicle identification conflict occurred (e.g., a GPS beacon is reporting a different vehicle identification from the vehicle identification assigned to the GPS beacon), a mileage exception (e.g., a vehicle exceed a mileage limit), and/or a geo-fence exception (e.g., a GPS beacon exceeding the geo-fence area), among other alerts and exceptions.

Referring now to FIGS. 4E-4F, illustrated are example GUI screens for displaying an exception report 420 in accordance with aspects of the present invention. Exception report 420 may include, for example, the vehicle's serial number, a date and/or time when an alert was generated, a type of alert generated, and a location where the alert was generated, among other information included in the exception report. In an aspect, a user may select one or more filters 422 to filter the exception report 420. Filters 422 may include, but are not limited to, a geo-fence violation, an acceleration violation, a deceleration violation, auto reports, and wired ignition turned off, among other filters. In addition, a user may search an exception history report 424 by entering search terms, such as a vehicle's identification number (e.g., the VIN number), a financial institution's name, a vendor's name, or a date range 426, among other search terms. Thus, it should be appreciated that a user may filter and/or search the exception report to locate exceptions relating to a particular alert, a particular vendor and/or financial institution, a particular date and/or time, and a particular vehicle.

Referring now to FIG. 4G, illustrated are example GUI screens 432, 434, and 436 for receiving an alert and viewing the location of one or more vehicles in accordance with an aspect. GUI screens 432 may include a satellite image of the geo-fence area, along with images of one or more vehicles located within and/or outside of the geo-fence area. In addition, GUI screen 434 may be used to illustrate the location of one or more vehicles. For example, a user of the system may enter in a vehicle's identification (e.g., a VIN number) and GUI screen 434 may display the requested vehicle's location. Thus, GUI screens 432 and 434 may illustrate images with the locations of one or more vehicles in real-time or near real-time.

GUI screen 436 illustrates an example alert a user of the system may receive. For example, the alert may be included in an e-mail message to the user. In addition, the alert may include, for example, the identification of the vehicle that triggered the alert, the location the alert was triggered, the time and/or date the alert was triggered, and a link to access the system, among other information. In an aspect, a user may select the link in the alert message and view the location of the vehicle that triggered the alert using, for example, GUI screens 432 and 434.

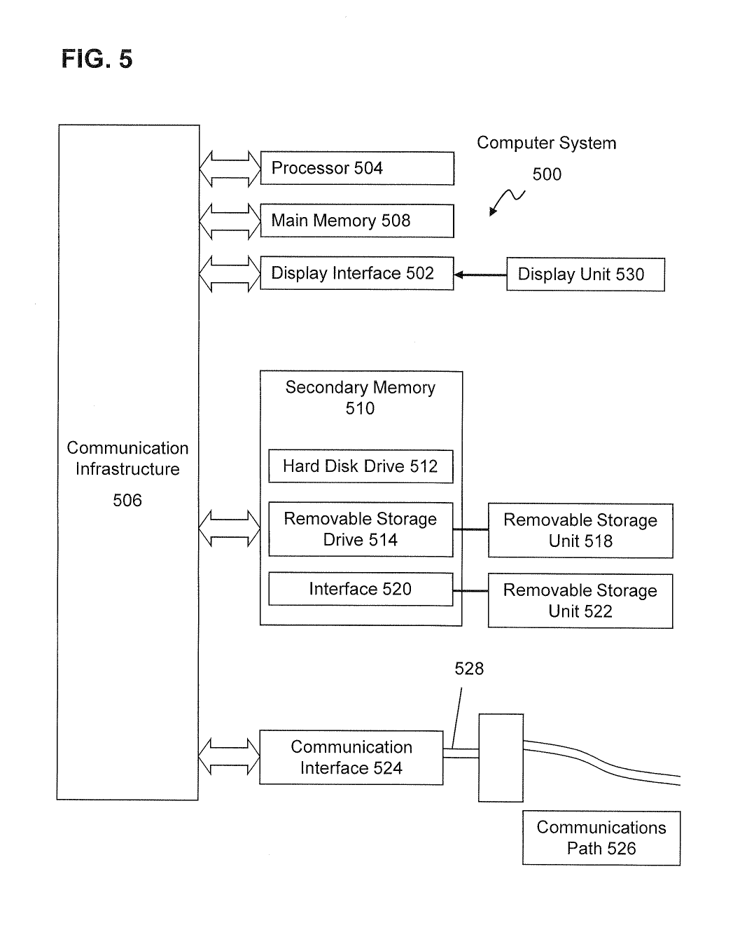

Aspects of the present invention may be implemented using hardware, software, or a combination thereof and may be implemented in one or more computer systems or other processing systems. In an aspect of the present invention, features are directed toward one or more computer systems capable of carrying out the functionality described herein. An example of such a computer system 500 is shown in FIG. 5.

Computer system 500 includes one or more processors, such as processor 504. The processor 504 is connected to a communication infrastructure 506 (e.g., a communications bus, cross-over bar, or network). Various software aspects are described in terms of this exemplary computer system. After reading this description, it will become apparent to a person skilled in the relevant art(s) how to implement aspects of the invention using other computer systems and/or architectures.

Computer system 500 can include a display interface 502 that forwards graphics, text, and other data from the communication infrastructure 506 (or from a frame buffer not shown) for display on a display unit 530. Computer system 500 also includes a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, a universal serial bus (USB) flash drive, etc. The removable storage drive 514 reads from and/or writes to a removable storage unit 518 in a well-known manner. Removable storage unit 518 represents a floppy disk, magnetic tape, optical disk, USB flash drive etc., which is read by and written to removable storage drive 514. As will be appreciated, the removable storage unit 518 includes a computer usable storage medium having stored therein computer software and/or data.

Alternative aspects of the present invention may include secondary memory 510 and may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528, which may be electronic, electromagnetic, optical or other signals capable of being received by communications interface 524. These signals 528 are provided to communications interface 524 via a communications path (e.g., channel) 526. This path 526 carries signals 528 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 580, a hard disk installed in hard disk drive 570, and signals 528. These computer program products provide software to the computer system 500. The invention is directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features in accordance with aspects of the present invention, as discussed herein. In particular, the computer programs, when executed, enable the processor 510 to perform the features in accordance with aspects of the present invention. Accordingly, such computer programs represent controllers of the computer system 500.

In an aspect of the present invention where the invention is implemented using software, the software may be stored in a computer program product and loaded into computer system 500 using removable storage drive 514, hard drive 512, or communications interface 520. The control logic (software), when executed by the processor 504, causes the processor 504 to perform the functions described herein. In another aspect of the present invention, the system is implemented primarily in hardware using, for example, hardware components, such as application specific integrated circuits (ASICs). Implementation of the hardware state machine so as to perform the functions described herein will be apparent to persons skilled in the relevant art(s).

In yet another aspect of the present invention, the invention is implemented using a combination of both hardware and software.

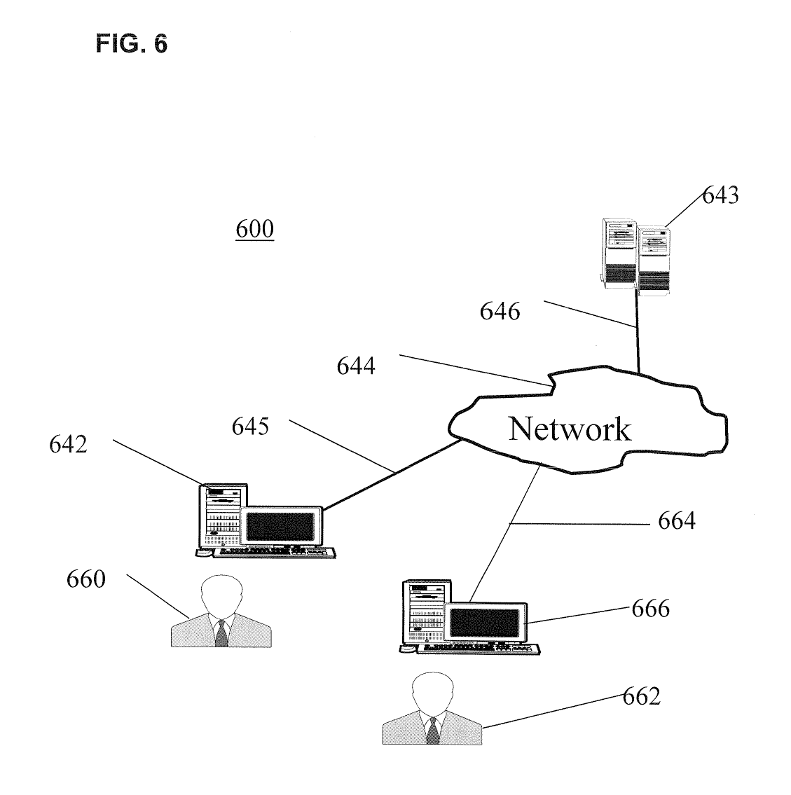

FIG. 6 shows a communication system 600 usable in accordance with aspects of the present invention. The communication system 600 includes one or more accessors 660, 662 (also referred to interchangeably herein as one or more “users”) and one or more terminals 642, 666. In one aspect of the present invention, data for use is, for example, input and/or accessed by accessors 660, 664 via terminals 642, 666, such as personal computers (PCs), minicomputers, mainframe computers, microcomputers, telephonic devices, or wireless devices, such as personal digital assistants (“PDAs”) or a hand-held wireless devices coupled to a server 643, such as a PC, minicomputer, mainframe computer, microcomputer, or other device having a processor and a repository for data and/or connection to a repository for data, via, for example, a network 644, such as the Internet or an intranet, and couplings 645, 646, 664. The couplings 645, 646, 664 include, for example, wired, wireless, or fiberoptic links. In another aspect of the present invention, the method and system of the present invention operate in a stand-alone environment, such as on a single terminal.

While the present invention has been described in connection with aspects of the present invention, it will be understood by those skilled in the art that variations and modifications of the aspects of the present invention described above may be made without departing from the scope of the invention. Other aspects will be apparent to those skilled in the art from a consideration of the specification or from a practice of the invention disclosed herein.

1. A method for reducing inventory or collateral verification effort, the method comprising:
receiving location information and collateral or inventory identification information from one or more location devices attached to one or more pieces of collateral or inventory;
storing the received location and collateral or inventory identification information for the one or more pieces of collateral or inventory;
identifying a location of one more pieces of collateral or inventory using the received location and collateral or inventory identification information; and
presenting information regarding the location of the one or more pieces of collateral or inventory.

2. The method of claim 1, wherein the presenting further comprises displaying on a map the location of the one or more pieces of collateral or inventory.

3. The method of claim 1, further comprising:
receiving parameters for a boundary surrounding an area for the one or more location devices to remain within;
determining whether the one or more location devices are within the boundary; and
generating and sending an alert if the one or more location devices exceed the boundary.

4. The method of claim 3, wherein the alert comprises one of an e-mail message, a short message service (SMS) message, a telephone call, a sound, an icon appearing on the dashboard, and a map displaying the location of the one or more pieces of collateral or inventory.

5. The method of claim 3, further comprising:
generating a location list with the one or more location devices within the boundary;
receiving an inventory list of collateral or inventory for the area;
comparing the location list with the collateral or inventory list to determine if one or more pieces of collateral or inventory are missing from the area; and
if one or more pieces of collateral or inventory are missing from the area, generating a report with information regarding the one or more pieces of collateral or inventory missing from the area.

6. The method of claim 5, wherein the report comprises one of the collateral or inventory identification information, a last location report for the collateral or inventory, time information, a vendor name, and a financial institutions.

7. The method of claim 5, further comprising:
receiving sales information from a vendor for one or more pieces of collateral or inventory;
determining a financial health of the vendor based upon the location list and the sales information; and
granting one or more financial loans to the vendor based upon the determined financial health.

8. The method of claim 2, wherein the parameters comprise one of a distance surrounding a plurality of collateral or inventory, a distance surrounding a location, a line on a map, a landmark, and a calculated area surrounding a center point.

9. The method of claim 2, further comprising:
receiving new parameters for a new boundary; and
determining whether the one or more locations devices are within the new boundary.

10. The method of claim 1, further comprising:
generating and sending an alert if the location device is removed from the piece of collateral or inventory.

11. The method of claim 1, wherein the presenting is performed on a dashboard.

12. The method of claim 1, wherein the location device comprises one of a global positioning system (GPS) beacon, a GPS receiver, and a cellular location device.

13. A system for reducing inventory or collateral verification effort, the system comprising:
a module for receiving location information and collateral or inventory identification information from one or more location devices attached to one or more pieces of collateral or inventory;
a module for storing the received location and collateral or inventory identification information for the one or more pieces of collateral or inventory;
a module for identifying a location of one more pieces of collateral or inventory using the received location and collateral or inventory identification information; and
a module for presenting on a dashboard information regarding the location of the one or more pieces of collateral or inventory.

14. A system for reducing inventory or collateral verification effort, the system comprising:
an information management system operable to receive location information and collateral or inventory identification information from one or more global positioning system devices coupled to one or more pieces of collateral or inventory and store the received location and collateral or inventory identification information for the one or more pieces of collateral or inventory;
the information management system being further operable to identify a location of the one more pieces of collateral or inventory using the received location and collateral or inventory identification information and present on a dashboard information regarding the location of the one or more pieces of collateral or inventory.

15. The system of claim 14, wherein the information management system is further operable to receive inventory information from a collateral management system with an inventory for a vendor.

16. The system of claim 15, wherein the information management system is further operable to:
compare the received location information and collateral or inventory identification information with the received collateral or inventory information; and
determine whether one or more pieces of collateral or inventory are missing from the collateral or inventory information.

17. The system of claim 16, wherein if one or more pieces of collateral or inventory are missing from the collateral or inventory information, the information management system is further operable to generate an alert to a client with information regarding the one or more pieces of collateral or inventory that are missing from the collateral inventory information.

18. The system of claim 14, wherein the information management system is further operable to:
receive sales information for one or more pieces of collateral or inventory from a vendor;
determine a current inventory for the vendor based upon the received location information and collateral or inventory identification information;
compare the current inventory with the received sales information; and
send to a client a financial history based upon the comparison of the current inventory and the received sales information.

19. The system of claim 14, wherein the information management system is further operable to:
determine a current location for the one or more pieces of collateral or inventory based upon the received location information and collateral or inventory identification information; and
send the current location the one or more pieces of collateral or inventory to a vendor.

20. A system for reducing inventory or collateral verification effort, the system comprising:
a processor;
a user interface functioning via the processor; and
a repository accessibly by the processor;
wherein location information and collateral or inventory identification information are received from one or more location devices attached to one or more pieces of collateral;
wherein the received location and collateral or inventory identification information are stored for the one or more pieces of collateral or inventory;
wherein a location of one more pieces of collateral or inventory is identified using the received location and collateral or inventory identification information; and
wherein information regarding the location of the one or more pieces of collateral or inventory is presented on a dashboard.

21. A computer product comprising a computer readable medium having control logic stored therein for causing a computer to monitor and track collateral or inventory, the control logic comprising:
first computer readable program code means for receiving location information and collateral or inventory identification information from one or more location devices attached to one or more pieces of collateral;
second computer readable program code means for storing the received location and collateral or inventory identification information for the one or more pieces of collateral or inventory;
third computer readable program code means for identifying a location of one more pieces of collateral or inventory using the received location and collateral or inventory identification information; and
fourth computer readable program code means for presenting on a dashboard information regarding the location of the one or more pieces of collateral or inventory.
